(19) United States
(12) Patent Application Publication
(10) Pub. No.: US 2019/0005778 A1
(43) Pub. Date: Jan. 3, 2019

(54) METHOD FOR OPERATING COMPETITIVE EVENTS

(71) Applicant: Barrel Racing Technologies, Ltd., Canton, OH (US)

(72) Inventor: Daniel Joseph Beers, II, Massillon, OH (US)

(21) Appl. No.: 16/020,042

(22) Filed: Jun. 27, 2018

Related U.S. Application Data
(60) Provisional application No. 62/526,062, filed on Jun. 28, 2017.

(51) Int. Cl. G07F 17/32

(52) U.S. Cl. CPC G07F 17/3288

(57) ABSTRACT

A method for operating a competitive event is disclosed. The method may include providing the competitive event with predetermined rules for a participant's participation, setting an entry qualification for the participant's participation in the competitive event and ensuring the entry qualification is satisfied. The method may include establishing a prize pool, allowing the plurality of participants to participate in the competitive event, and offering each of the plurality of participants who are not satisfied with the outcome of the participant's participation in the competitive event an opportunity to participate in an additional round upon satisfaction of a reentry qualification. The method may include adjusting the prize pool and allowing the at least one reentry participant to participate in the at least one additional round of the competitive event. The method may include ranking each participant and awarding a monetary amount from the prize pool to at least one participant.

### CROSS REFERENCE TO RELATED APPLICATIONS

This application claims the benefit of U.S. Provisional Application Ser. No. 62/526,062, filed on Jun. 28, 2017; the disclosure of which is incorporated herein by reference.

### BACKGROUND

### Technical Field

The present disclosure relates generally to the field of competitive events. More particularly, the present disclosure relates to a method of operating competitive events. Specifically, the present disclosure relates to a method for operating competitive events where a competitive event is provided for participants' participation upon the satisfaction of entry qualifications and monetary awards may be paid out to participants based upon an overall ranking of the participants that participated in the competitive event.

### Background Information

Competitive events are extremely popular not only for viewers, but also for operators and participants. Competitive event operators and participants sometimes look for new and exciting ways to enhance their overall experience which may include enhancing an operator's profitability for operating the competitive event and a participant's potential compensation for participating in the competitive event.

Current methods for operating competitive events have some shortcomings. For example, current methods for operating competitive events limit the amount of potential revenue and available prize money by only allowing collection of a single monetary payment or a single participation in the competitive event being operated.

### SUMMARY

Issues continue to exist with methods for operating competitive events. Therefore, what is needed is an improved method for operating competitive events, including improved participation parameters, in which the above shortcomings are overcome. The present disclosure addresses these and other issues.

In one aspect, the disclosure may provide a method for operating competitive events comprising: providing a competitive event with predetermined rules for a participant's participation; setting an entry qualification for the participant's participation in the competitive event; establishing that a plurality of participants have satisfied the entry qualification; establishing a prize pool; allowing the plurality of participants to participate in the competitive event; determining whether each of the plurality of participants is satisfied with an outcome of each of the plurality of participants' participation in the competitive event; offering each of the plurality of participants who are not satisfied with the outcome of the participant's participation in the competitive event an opportunity to participate in at least one additional round of the competitive event based upon a reentry qualification, wherein the reentry qualification must be satisfied for each additional round if more than one additional round is offered; establishing that at least one reentry participant has satisfied the reentry qualification; determining if the prize pool should be adjusted; allowing the at least one reentry participant to participate in the at least one additional round of the competitive event; determining an overall ranking of the plurality of participants and the at least one reentry participant that participated in the competitive event based upon the predetermined rules of the competitive event; and awarding a monetary amount from the prize pool to at least one of the plurality of participants or to the at least one reentry participant that participated in the competitive event based upon the overall ranking.

In one aspect, the disclosure may provide a method for operating a competitive event comprising effecting at least one participant to ride a horse across a start line/finish line and around at least one barrel in response to receiving an entry qualification and offering the at least one participant an opportunity to ride the horse across the start line/finish line and around the at least one barrel by satisfying a reentry qualification.

The method may further include effecting the at least one participant to ride the horse across the start line/finish line and around the at least one barrel in response to receiving the reentry qualification. In one example, the entry qualification is a threshold rank in a previous competitive event. In one example, the entry qualification and the reentry qualification are monetary payments.

The method may further include establishing a prize pool including, at least in part, a portion of the monetary payment from the entry qualification and a portion of the monetary payment from the reentry qualification. The prize pool may further include, at least in part, a monetary payment from a sponsor of the competitive event.

The method may further include ranking each participant that rode the horse and awarding a monetary amount from the prize pool to at least one of the ranked participants.

In one example, ranking each participant that rode the horse may further include establishing at least one division and placing each ranked participant in the at least one division.

In one example, awarding the monetary amount to at least one of the ranked participants may further include awarding at least a portion of the monetary amount from the prize pool to at least one of the ranked participants in each of the at least one division.

In one aspect, the disclosure may provide a method for operating a competitive event is disclosed. The method may include providing the competitive event with predetermined rules for a participant's participation, setting an entry qualification for the participant's participation in the competitive event and ensuring the entry qualification is satisfied. The method may include establishing a prize pool, allowing the plurality of participants to participate in the competitive event, and offering each of the plurality of participants who are not satisfied with the outcome of the participant's participation in the competitive event an opportunity to participate in an additional round upon satisfaction of a reentry qualification. The method may include adjusting the prize pool and allowing the at least one reentry participant to participate in the at least one additional round of the competitive event. The method may include ranking each participant and awarding a monetary amount from the prize pool to at least one participant.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a diagram of a barrel racing competition system; and

FIG. 2 is a flow chart illustrating a method of operating competitive events in accordance with the present disclosure.

Similar numbers refer to similar parts throughout the drawings.

### DETAILED DESCRIPTION

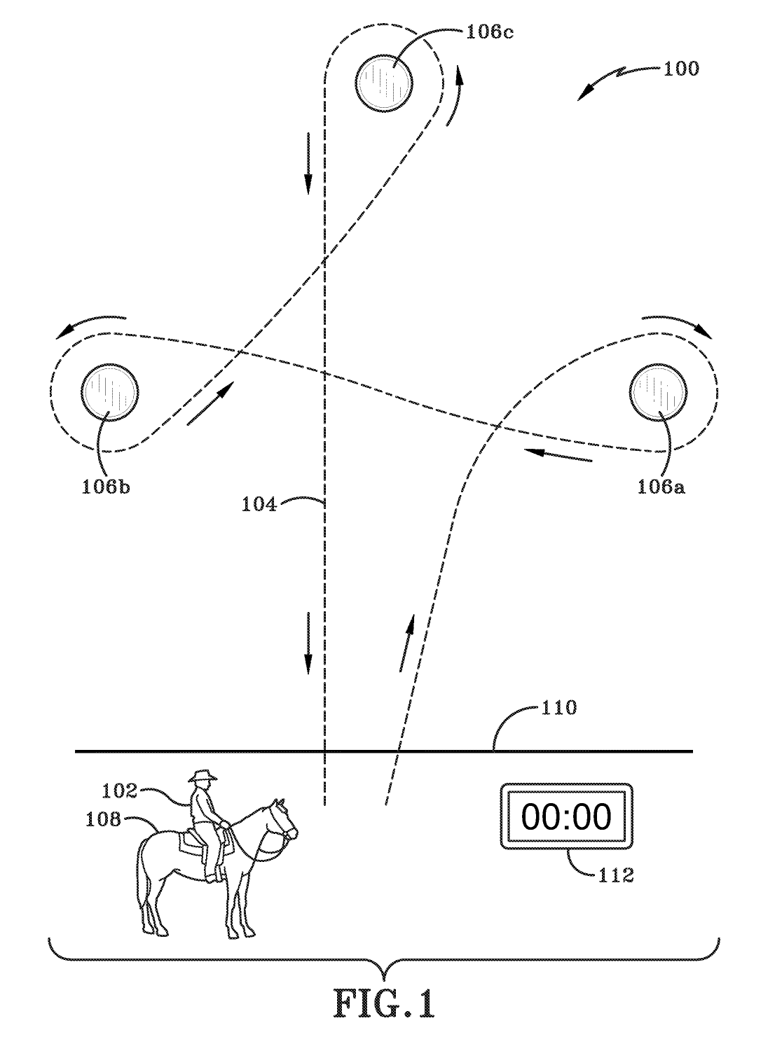

Reference is made to FIG. 1 which is a diagram of a typical barrel racing competition system 100 and operation thereof. The barrel racing competition system 100 may include a participant 102, a triangular, cloverleaf pattern 104, a right barrel 106a, a left barrel 106b, a center barrel 106c, a horse 108, a start line/finish line 110 and a timer 112. In accordance with an aspect of the present disclosure, the method for operating competitive events may be applied to operating a horse event such as a barrel racing competition as more fully described below.

A barrel racing competition is a popular competitive event where the top participants 102 in each barrel racing competition may receive a monetary award based upon a predetermined ranking system. In a barrel racing competition, the participant 102 competes for the fastest time in running the triangular, cloverleaf pattern 104 around the right barrel 106a, left barrel 106b and center barrel 106c. The barrels 106a, 106b, and 106c, are usually fifty-five gallon metal barrels 106a, 106b, and 106c, which are placed in specific positions and at specific distances from each other within the system 100. It is envisioned that devices other than barrels 106a, 106b and 106c may be utilized in any suitable manner.

The participant 102 and the participant's horse 108 may begin by getting a running start, crossing the start line/finish line 110 and heading towards the right barrel 106a or the left barrel 106b. When the participant 102 crosses the start line/finish line 110, the timer 112 is activated which continues to run until the participant 102 once again crosses the start line/finish line 110 heading in the opposite direction from which the participant 102 first crossed the start line/finish line 110. If the participant 102 first chooses to go towards the right barrel 106a, the participant 102 must make a right turn around the right barrel 106a, a left turn around the left barrel 106b and a left turn around the center barrel 106c in the triangular, cloverleaf pattern 104. If the participant 102 first chooses to go towards the left barrel 106b, the participant 102 must make a left turn around the left barrel 106b, a right turn around the right barrel 106a and a right turn around the center barrel 106c once again in the triangular, cloverleaf pattern 104.

After the participant 102 makes the final turn around the center barrel 106c, the participant 102 heads toward the start line/finish line 110, and once the participant 102 crosses the start line/finish line 110, the timer 112 is stopped and the final number represents the participant's 102 completion time. In the event a participant 102 knocks over a barrel 106a, 106b or 106c, during the run, the participant 102 may be assessed a penalty, which usually lowers a participant's 102 ranking preventing them from receiving a monetary award or prize. Further, if the participant 102 does not complete the system 100 in the triangular, cloverleaf pattern 104, the participant 102 may be disqualified from the barrel racing competition.

The rankings of the participants 102 may be based upon the participants' 102 completion time, with the participant 102 having the fastest time of the barrel racing competition winning the event. Monetary awards may be paid out to the participants 102 based upon the rank that the participants 102 achieved during the barrel racing competition and many methods may be used to determine the participants' 102 ranking.

Depending on the particular barrel racing competition, there may be more than one round of competition per barrel racing competition. For example, the barrel racing competition may consist of a first and second round of competition where a certain number of the participants 102 qualify to participate in the second round based upon the participants' rankings of the first round. For example, a barrel racing competition may have twenty participants 102 competing against each other. The operator may elect to hold two rounds where the ten participants 102 with the fastest time from the first round advance to the second round. The participants 102 that qualified for the second round then compete again and the participant 102 with the fastest time of that round would win the event and the other participants 102 would be ranked accordingly.

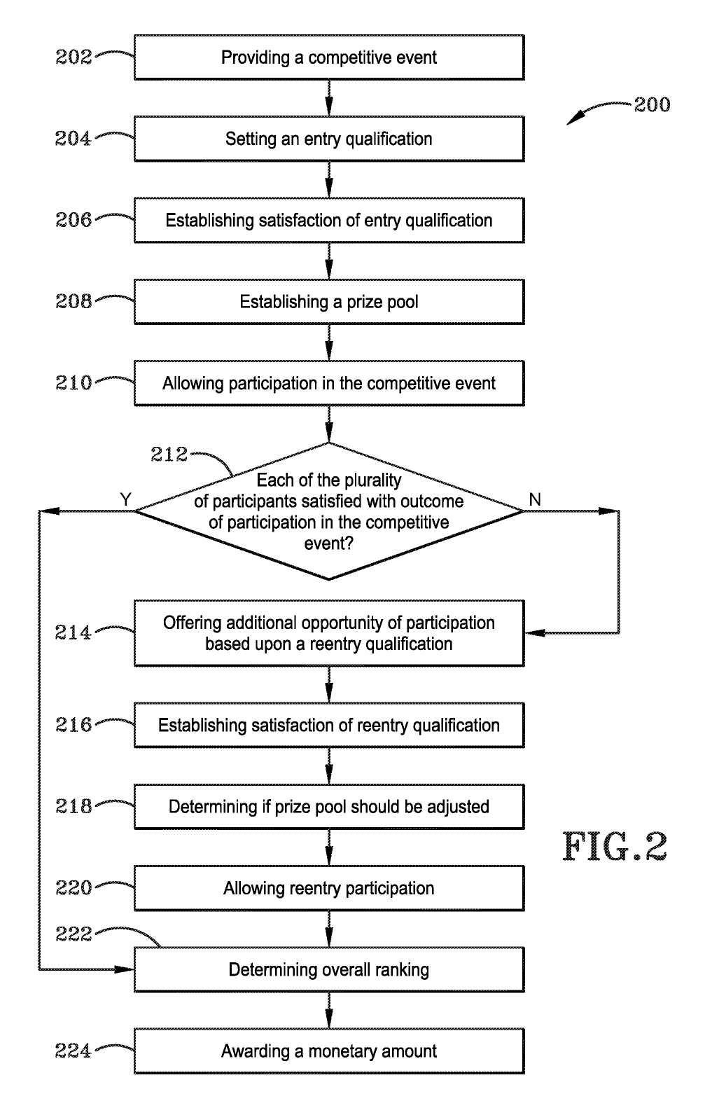

Although the method of the present disclosure may be applied to any suitable competitive event, which for the purposes of this disclosure may include competitive sports and horse events, the method will be substantially described in relation to a barrel racing competition. As such, reference is made to FIG. 2, which is a flowchart disclosing a method 200 of operating competitive events described hereinbefore.

The method 200 is initiated at step 202, wherein a competitive event is provided with predetermined rules for a participant's participation. Such a competitive event may be any suitable competitive event such as a poker game, a horse event, a horse show competition, a rodeo event, among many other competitive events. Each competitive event may have predetermined rules of participation. For example, if the competitive event provided is a bull riding rodeo event, the bull riding rodeo event may be conducted in accordance with the established rules of the particular operator. In the event the competitive event is a barrel racing competition, the barrel racing competition may be conducted in accordance with the established rules of the operator. Typical barrel racing competition rules are more fully described in the present disclosure.

In step 204 of method 200, an entry qualification is set for the participant's participation in a competitive event. The entry qualification may be a monetary amount or any other qualification. For example, in a barrel racing competition, the entry qualification may be based on a performance in a prior barrel racing competition that meets a certain threshold to qualify for a subsequent barrel racing competition. In this example, achieving a certain ranking in a first barrel racing competition may be a prerequisite to becoming qualified to participate in a second barrel racing competition. Alternatively, the entry qualification may be a monetary amount as determined by the operator or another appropriate person or entity such as a sponsor of the barrel racing competition.

By satisfying the entry qualification, a participant is entitled to participate in the barrel racing competition in the specified format of the particular barrel racing competition. If the specified format of the particular barrel racing competition is a competition having a single round, the participant, by satisfying the entry qualification, would be entitled to participate in the single round of competition and the ranking of the participant would be based on the participant's performance in that single round. If the specified format of the particular barrel racing competition is a two round competition, the participant, by satisfying the entry qualification, would be entitled to participate in at least the first round, and depending on the ranking of the participant's performance in the first round, the participant may be entitled to participate in the second round. Further, in some cases, the entry qualification may be waived.

In step 206 of method 200, establishing whether a plurality of participants have satisfied the entry qualification is accomplished. For example, in a barrel racing competition, the entry qualification may be the payment of a monetary amount, and, in that case, the monetary amount may be collected from the participants through various methods including by receiving cash payments, credit card payments, electronic wire transfer payments or any other methods of payment, and, once received, the participant has satisfied the entry qualification.

In the event the entry qualification is based on a performance in a prior barrel racing competition that meets a certain threshold to qualify for the barrel racing competition the participant is attempting to enter into, the participant satisfies the entry qualification upon confirmation that the participant has placed at or above the required threshold in the previous barrel racing competition.

For example, entry into a barrel racing competition may be predicated on placing in the top five of all participants participating in a previous barrel racing competition. Thus, in the event a participant places in the top five of all participants that participated in the previous barrel racing competition, and upon confirmation of the top five ranking of the participant, the entry qualification would be satisfied, and the participant would be entitled to participate in the subsequent barrel racing competition and would not be subject to any further entry qualifications.

In step 208 of method 200, a prize pool is established. The prize pool may be established at any time and may consist of various forms of consideration. For example, in a barrel racing competition, and in the event the entry qualification is a payment of a monetary amount, the prize pool may be established by transferring a portion of the monetary amount collected from the entry qualifications to the prize pool. Additional monetary amounts or consideration may also be added to the prize pool such as when a sponsor or other person or entity contributes a monetary amount or other consideration to the prize pool amount.

In step 210 of method 200, the plurality of participants that have satisfied the entry qualification are allowed to participate in the competitive event. As stated above, in the event the competitive event is a barrel racing competition, the participants would participate in the specified format of the particular barrel racing competition. If the specified format of the particular barrel racing competition is a competition having a single round, the participant would be entitled to participate in the single round of competition and the ranking of the participant would be based on the participant's performance in that single round. If the specified format of the particular barrel racing competition is a two round competition, then satisfying the entry qualification would allow a participant to participate in at least the first round, and depending on the ranking of the participant's performance in the first round, the participant may be entitled to participate in the second round.

In step 212 of method 200, determining whether each of the plurality of participants is satisfied with an outcome of each of the plurality of participants' participation in the competitive event is accomplished. In the event the participant is satisfied with the participant's participation in the competitive event, the next step is step 222 below. In the event the participant is not satisfied with the participant's participation in the competitive event, the next step is step 214 below.

In step 214 of method 200, each of the plurality of participants who are not satisfied with the outcome of the participant's participation in the competitive event are offered an opportunity to participate in at least one additional round of the competitive event based upon satisfying a reentry qualification, wherein the reentry qualification must be satisfied for each additional round if more than one additional round is offered. In the event the competitive event is a barrel racing competition, some operators may allow for an additional round of competition which increases revenue for the operator. Participants may desire to participate in the additional round in order to improve upon a past performance, among other reasons. Barrel racing competitions are often decided by hundredths of seconds, and minor mistakes made by a participant are often costly to the participant's overall ranking in the barrel racing competition. Therefore, participants typically desire to improve upon a past performance and may be willing to satisfy the reentry qualification in order to participate in an additional round of the barrel racing competition.

The reentry qualification may be any qualification including, but not limited to, the payment of a monetary amount, and, in that case, the monetary amount may be collected from the participants through various methods including by receiving cash payments, credit card payments, electronic wire transfer payments or any other methods of payment, and, once received, the participant has satisfied the entry qualification.

In step 216 of method 200, establishing whether at least one reentry participant has satisfied the reentry qualification is accomplished. For example, in a barrel racing competition, the reentry qualification may be the payment of a monetary amount, and, in that case, the monetary amount may be collected from the participants through various methods including by receiving cash payments, credit card payments, electronic wire transfer payments or any other methods of payment and, once received, the participant has satisfied the entry qualification.

In step 218 of method 200, determining whether the prize pool should be adjusted is accomplished. For example, in barrel racing competition, an operator may set the reentry qualification to be payment of a monetary amount. In the event a reentry participant pays the monetary amount associated with the reentry qualification, the operator may desire to add a portion of that monetary amount to the prize pool; however, this is not required and the operator may keep the additional monetary amount. In this case, the participants may be more willing to satisfy the reentry qualification requirements and participate in additional rounds based upon an increase in potential compensation for a performance that places within the participant's desired overall ranking, among other reasons.

In step 220 of method 200, the at least one reentry participant is allowed to participate in the at least one additional round of the competitive event. In a barrel racing competition having a single round of competition with the opportunity to participate in an additional round based upon satisfying the reentry qualification, the participant is able to participate in the additional round based upon satisfying the reentry qualification.

In step 222 of method 200, an overall ranking of the plurality of participants and, if necessary, the at least one reentry participant that participated in the competitive event is determined based upon the predetermined rules of the competitive event. For example, in a barrel racing competition, a typical ranking system may include a number of divisions. In the event a barrel racing competitions includes four divisions, all participants participate in the event and are classified within one of the four divisions. Each division may be determined by a period of time, where the participant with the fastest time for the barrel racing competition sets the mark for the first division and the other divisions may be based off of that time.

For example, a barrel racing competition may use a ranking system wherein the first division is based on the fastest time completed at the event, the second division is based on the fastest time plus ½ of a second, the third division is based on the fastest time plus 1 second and the fourth division is based on the fastest time plus 2 seconds. In this scenario, all participants within ½ of a second of the fastest time would be classified within the first division, all participants within ½ of a second and 1 second of the fastest time would be classified within the second division, all participants within 1 second and 2 seconds of the fastest time would be classified within the third division and all participants having a time of 2 seconds or more than the fastest time would be classified within the fourth division.

In step 224 of method 200, a monetary amount from the prize pool is awarded to at least one of the plurality of participants and/or to the at least one reentry participant that participated in the competitive event based upon the overall ranking. For example, in a barrel racing competition, typical monetary payments are made to participants based upon an overall ranking within divisions. Thus, in a barrel racing competition having four divisions, an example payout scenario may include a portion of the prize pool being allocated to each of the four divisions, and a portion of each of those allocations being awarded to the participants within that division.

For example, an operator may elect to keep 25% of the prize pool as revenue and allocate 75% of the prize pool to the four divisions. In this case, the first division may be allocated 40% of the 75% allocation, the second division may be allocated 30% of the 75% allocation, the third division may be allocated 20% of the 75% allocation and the fourth division may be allocated 10% of the 75% allocation. The operator may then determine how to allocate the monetary awards within each division. For example, if there are two participants within the first division, the operator may elect to have the participant with the fastest time be awarded 60% of the 40% allocation and the participant with the second fastest time be awarded 40% of the 40% allocation. The participants that achieved a ranking within the other divisions would be paid out in a similar manner. Alternatively, one participant could receive 100% of the money allocated from the prize pool or the top three participants overall could receive a portion of the prize pool allocation as determined by the operator.

In accordance with one aspect of the present disclosure, and in operation, the competitive event may be a barrel racing competition. The barrel racing competition may include predetermined rules for a barrel racing participant's participation. An entry qualification may be set for the barrel racing participant's participation in the barrel racing competition. Next, establishing whether a plurality of participants have satisfied the entry qualification is accomplished.

After establishing that a plurality of participants have satisfied the entry qualification, a barrel racing prize pool is established. The plurality of barrel racing participants participate in the barrel racing competition. Next, determining whether each of the plurality of participants is satisfied with an outcome of each of the plurality of participants' participation in the competitive event is accomplished. In the event the participant is satisfied with the participant's participation in the competitive event, the overall ranking of that participant is based on that particular participation.

In the event the participant is not satisfied with the participant's participation in the competitive event, the participant is then offered an opportunity to participate in at least one additional round of the barrel racing competition based upon satisfying a reentry qualification, wherein the reentry qualification must be satisfied for each additional round if more than one additional round is offered. Then, establishing whether at least one reentry barrel racing participant has satisfied the reentry qualification is accomplished.

Next, determining whether the barrel racing prize pool should be adjusted is accomplished. The at least one reentry barrel racing participant participates in the at least one additional round of the barrel racing competition. An overall ranking of the plurality of barrel racing participants and, if necessary, the at least one reentry barrel racing participant that participated in the barrel racing competition is determined based upon the predetermined rules of the barrel racing competition. Next, a monetary amount from the barrel racing prize pool is awarded to at least one of the plurality of barrel racing participants or to the at least one reentry barrel racing participant that participated in the barrel racing competition based upon the overall ranking.

Although the method 200 has been applied to barrel racing competitions within this disclosure, it is understood that the method may be applied to many competitive events and/or competitive sports and no unnecessary limitations are to be applied from the application to barrel racing competitions.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A method for operating a horse event comprising:
effecting at least one participant to participate in the horse event in response to receiving an entry qualification; and
offering the at least one participant an additional opportunity to participate in the horse event by satisfying a reentry qualification.

2. The method of claim 1, wherein the horse event is a barrel racing competition and the method further comprises:
effecting the at least one participant to ride a horse across a start line/finish line and around at least one barrel in response to receiving the entry qualification;
offering the at least one participant an opportunity to ride the horse across the start line/finish line and around the at least one barrel by satisfying the reentry qualification; and
effecting the at least one participant to ride the horse across the start line/finish line and around the at least one barrel in response to receiving the reentry qualification.

3. The method of claim 1, wherein the entry qualification is a threshold rank in a previous horse event.

4. The method of claim 1, wherein the entry qualification and the reentry qualification are monetary payments.

5. The method of claim 4, further comprising:
establishing a prize pool including, at least in part, a portion of the monetary payment from the entry qualification and a portion of the monetary payment from the reentry qualification.

6. The method of claim 5, wherein the prize pool further includes, at least in part, a monetary payment from a sponsor of the horse event.

7. The method of claim 5, further comprising:
ranking each participant that participated in the horse event.

8. The method of claim 7, further comprising:
awarding a monetary amount from the prize pool to at least one of the ranked participants.

9. The method of claim 7, wherein ranking each participant that participated in the horse event further comprises:
establishing at least one division; and
placing each ranked participant in the at least one division.

10. The method of claim 9, wherein awarding the monetary amount to at least one of the ranked participants further comprises:
awarding at least a portion of the monetary amount from the prize pool to at least one of the ranked participants in each of the at least one division.

11. A method for operating a competitive event comprising:
providing the competitive event with predetermined rules for a participant's participation;
setting an entry qualification for the participant's participation in the competitive event;
establishing that a plurality of participants have satisfied the entry qualification;
establishing a prize pool;
allowing the plurality of participants to participate in the competitive event;
determining whether each of the plurality of participants is satisfied with an outcome of each of the plurality of participants' participation in the competitive event;
offering each of the plurality of participants who are not satisfied with the outcome of the participant's participation in the competitive event an opportunity to participate in at least one additional round of the competitive event based upon a reentry qualification, wherein the reentry qualification must be satisfied for each additional round if more than one additional round is offered;
establishing that at least one reentry participant has satisfied the reentry qualification;
allowing the at least one reentry participant to participate in the at least one additional round of the competitive event;
determining an overall ranking of the plurality of participants and the at least one reentry participant that participated in the competitive event based upon the predetermined rules of the competitive event; and
awarding a monetary amount from the prize pool to at least one of the plurality of participants or to the at least one reentry participant that participated in the competitive event based upon the overall ranking.

12. The method of claim 11, wherein the entry qualification is a monetary payment.

13. The method of claim 11, wherein the entry qualification is a threshold rank in a previous competitive event.

14. The method of claim 11, wherein the prize pool includes at least a portion of the monetary payment from the entry qualification.

15. The method of claim 11, wherein the prize pool includes at least a portion of a monetary payment from a sponsor.

16. The method of claim 11, wherein the reentry qualification is a monetary payment.

17. The method of claim 11, wherein determining the overall ranking of the plurality of participants and the at least one reentry participant that participated in the competitive event based upon the predetermined rules of the competitive event further comprises:
establishing at least one division; and
placing each participant of the plurality of participants and the at least one reentry participant in one of the at least one division.

18. The method of claim 17, wherein awarding the monetary amount from the prize pool to at least one of the plurality of participants or to the at least one reentry participant that participated in the competitive event based upon the overall ranking further comprises:
awarding at least a portion of the monetary amount from the prize pool to at least one of the plurality of participants or to the at least one reentry participant in each of the at least one division.

19. The method of claim 11, further comprising:
determining if the prize pool should be adjusted.

20. The method of claim 19, wherein determining if the prize pool should be adjusted further comprises:
adding at least a portion of the monetary payment from the reentry qualification to the prize pool.
